(19) United States
(12) Patent Application Publication
(10) Pub. No.: US 2025/0135502 A1
(43) Pub. Date: May 1, 2025

(54) SURFACE CLEANING APPARATUS AND METHOD THEREOF

(71) Applicant: DANIEL MARTINSON, Fridley, MN (US)

(72) Inventor: DANIEL MARTINSON, Fridley, MN (US)

(21) Appl. No.: 18/929,568

(22) Filed: Oct. 28, 2024

Related U.S. Application Data
(60) Provisional application No. 63/545,920, filed on Oct. 26, 2023.

(51) Int. Cl. B08B 1/10; A63B 60/00; B08B 1/30

(52) U.S. Cl. CPC B08B 1/10; A63B 60/00; B08B 1/30

(57) ABSTRACT

A surface cleaning apparatus including a housing member and a cleaning member for cleaning a textured surface. The cleaning member can be removably coupled from the housing portion. The housing member can include a housing member having a first end and a second end, wherein the first end and second end can define the length of the housing member. A first end of the of the housing member can be enclosed and form top cap portion. The top wall portion includes an interior surface and an exterior surface. The second end of the housing member can be open. A sidewall extending generally perpendicular from the first end towards the second end forms a cavity. The cleaning member can be comprised of an elastomeric material.

### CROSS-REFERENCE

This Patent Application claims priority to U.S. Provisional Application 63/545,920 filed Oct. 26, 2023, the disclosure of which is considered part of the disclosure of this application and is hereby incorporated by reference in its entirety.

### FIELD OF THE INVENTION

This invention relates generally to an apparatus for cleaning a surface of an object. In one aspect, the present disclosure relates to an apparatus for cleaning a texture surface of an object to remove any debris or build up from the textured surface.

### BACKGROUND

In various industries there may be surfaces that have a texture in order to have apply additional grip or friction against an object. As the textured surface encounters the object, the textured portion of the surface can accumulate debris and material/residue from the repetitive contact with the object. In order to maintain the textured surface, it may be necessary to clean the surface periodically to avoid having to replace the surface in its entirety.

Specifically, in racket and paddle sports, the surface of a racket or paddle can accumulate debris and material when contacting a ball or other object. This can result in diminishing performance and ability to put spin on the ball upon contact. To avoid replacing the entire hitting surface, there exists a need for a surface cleaning apparatus to remove debris and material from the hitting surface and provide consistent performance throughout a game.

### BRIEF SUMMARY OF THE INVENTION

In one aspect, this disclosure is related to an apparatus for cleaning the surface of a textured surface.

In another aspect, this disclosure is related to a surface cleaning apparatus for removing particles from the surface of a paddle that can include a housing member and a first cleaning member. The housing member can have a first end and a second end, wherein the first end and second end can define the length of the housing member. The first end can be enclosed to form a top surface, and the second end can be open. A sidewall extending generally perpendicular from the first end towards the second end can form an interior cavity. The first cleaning member having a first end and a second end, wherein the first end and second end can define the length of the cleaning member. At least a portion of the first cleaning member is configured to fit within the cavity of the housing member.

In another aspect, this disclosure is related to a cleaning apparatus configured to remove debris and material from a textured paddle surface to maintain the hitting surface of the paddle. The cleaning apparatus can include a housing portion and a cleaner portion.

In another aspect, the disclosure is related to a surface cleaning apparatus for removing particles from the surface of a paddle comprising a housing member having a first end and a second end. The first end and second end can define the length of the housing member, wherein the first end is enclosed, and the second end is open. A sidewall extending generally perpendicular from the first end towards the second end can form an interior cavity of the housing member. A first cleaning member having a first end and a second end with the first end and second end can define the length of the cleaning member. At least a portion of the first cleaning member is configured to fit within the cavity of the housing member. The cleaning member can have an exterior diameter, and the cavity of the housing member has an interior diameter. The exterior diameter of the cleaning member can be equal to or less than the interior diameter of the cavity of the housing member allowing for the cleaning member fit within the cavity of the housing member. The cleaning member can be comprised of a cross-linked polyethylene.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of an exemplary embodiment of a surface cleaning apparatus of the present disclosure.

FIG. 2 is a side perspective view of an exemplary embodiment of a surface cleaning apparatus of the present disclosure.

FIG. 3 is a bottom perspective view of an exemplary embodiment of a surface cleaning apparatus of the present disclosure.

FIG. 4 is a perspective view of an exemplary embodiment of a surface cleaning apparatus of the present disclosure, wherein a cleaning member is removed from the housing member.

FIG. 5A is a perspective view of an exemplary embodiment of a surface cleaning apparatus of the present disclosure being used to remove material embedded into the textured surface of a paddle surface.

FIG. 5B is an enlarged perspective view of FIG. 5A of an exemplary embodiment of a surface cleaning apparatus of the present disclosure.

FIG. 6 is a perspective view of an exemplary embodiment of a surface cleaning apparatus of the present disclosure, wherein a cleaning member is removed from the housing member.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit, or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

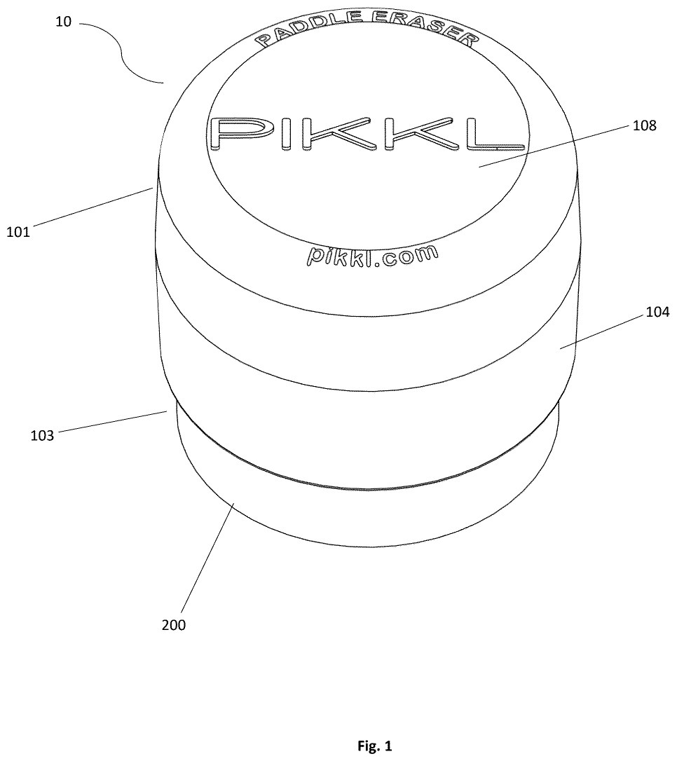

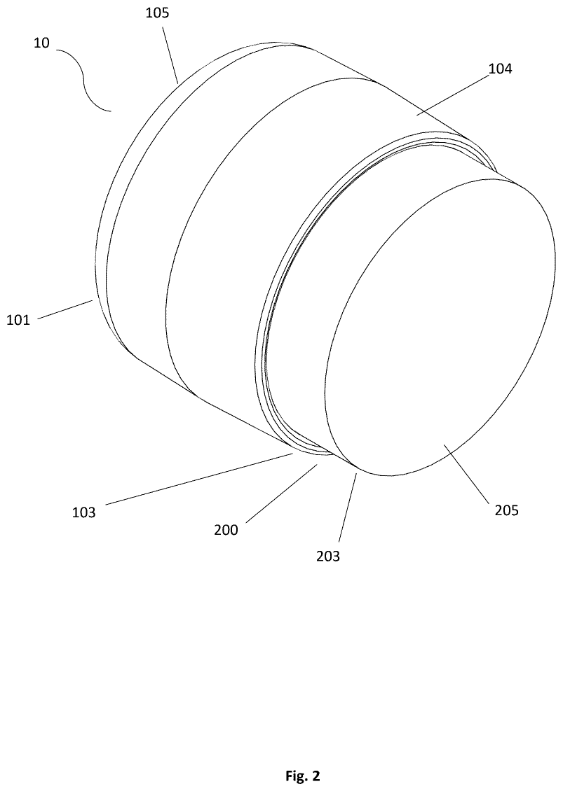

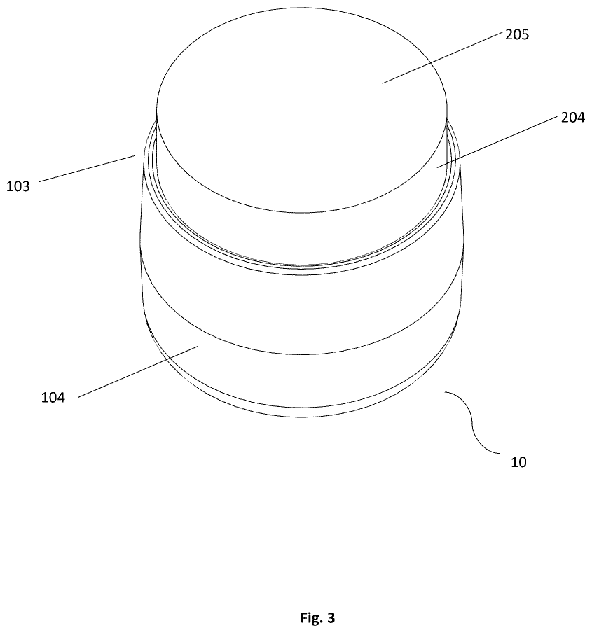

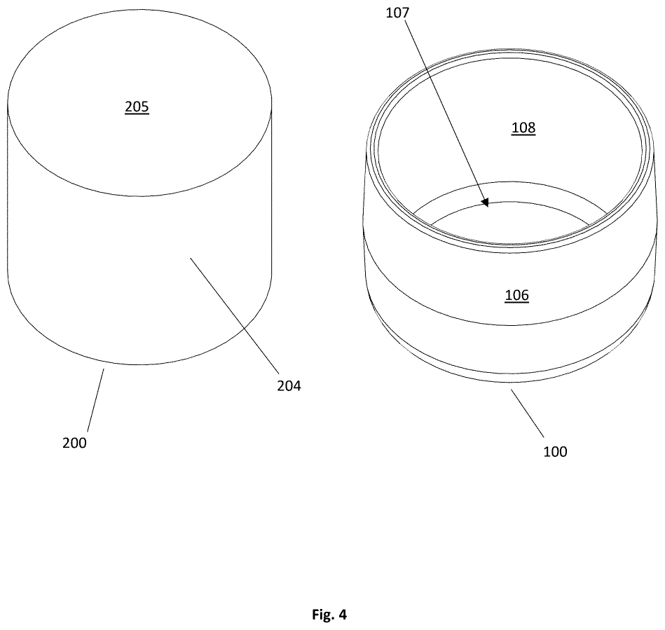

Referring now to FIGS. 1-3 a surface cleaning apparatus 10 of the present disclosure can include a housing member 100 having a first end 101 and a second end 103, wherein the first end 101 and second end 103 can define the length of the housing member 100. A first end 101 of the of the housing member can be enclosed and form top cap portion. The top wall portion 105 have include an interior surface 106 and an exterior surface 108. The second end 103 of the housing member 100 can be open. A sidewall 104 extending generally perpendicular from the first end towards the second end forms a cavity 107 as shown in FIG. 4. In some exemplary embodiments, the housing member 100 can be comprised of any suitable material, including but not limited to a metal, plastic, polymer or thermoplastic material. The sidewall 104 can have an interior surface 106 and an exterior surface 108.

The apparatus 10 can additionally include a first cleaning member 200 having a first end 201 and a second end 203, wherein the first end 201 and second end 203 can define the length of the cleaning member 200. The cleaning member 200 can similarly have a sidewall 204 extending between the first end 201 and the second end 203. Each end of the cleaning member can have a generally planar surface 205. In some exemplary embodiments, the surface 205 can take other suitable configurations such as a rounded, curved, spherical surface. A cleaning member 200 can take any suitable shape. As shown in FIG. 4, one exemplary embodiment can have a cylindrical configuration, but it should be understood that other shapes may be suitable. The length of the first cleaning member 200 can be greater than the length of the housing member 100. Alternatively, the housing member 100 can have a stop within the cavity to allow a portion of the cleaning member 200 to extend past the second end 103 of the housing member 100. The cleaning member 200 can be positioned within the cavity 107 of the housing member 100 and maintained within the housing 100 during use of cleaning a surface 21 of an implement 20, such as a paddle. The cavity can include an interior sidewall. The interior sidewall can optionally have one or more engagement members to help engage and maintain the cleaning member within the cavity. The engagement members 109 can include protrusions that provide a greater friction fit of the cleaning member within the cavity 107.

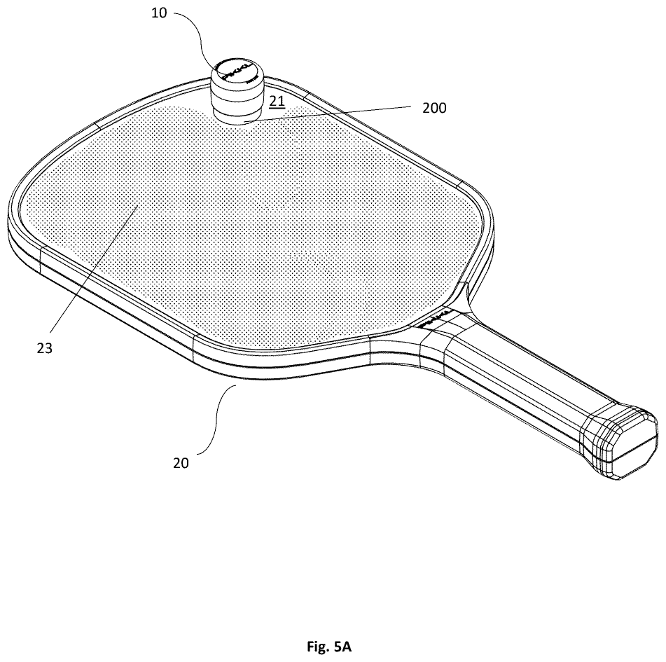

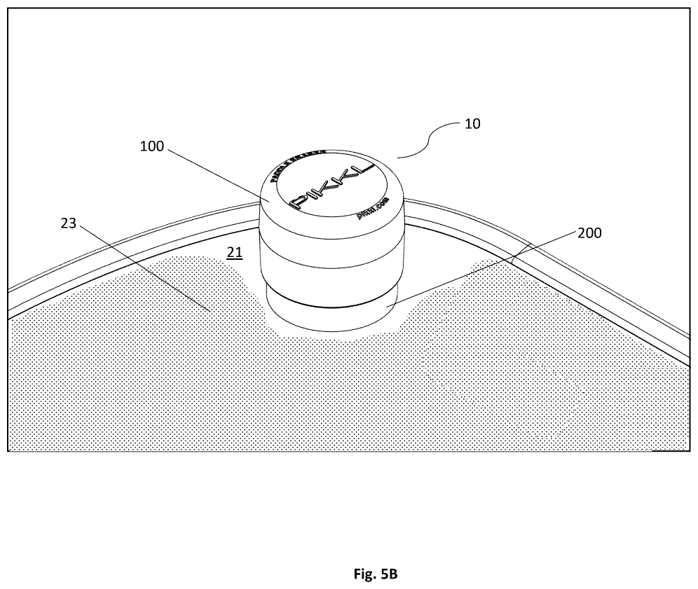

The edge of the first surface of the cleaning member can have a chamfered or rounded edge to allow a user to easily move the apparatus along the surface of the paddle. A paddle surface 22 can accumulate debris 23 and material from a ball that can reduce the ability for a user to apply spin when contacting the ball. As shown in FIGS. 5A-B, the apparatus 10 of the present disclosure can be utilized to remove debris and material that has been accumulated on the paddle surface 21 to restore the paddle surface and maintain or prolong the life of a paddle surface 22. This can ensure adequate spin is applied throughout a match or game.

In some exemplary embodiments, the housing 100 can be injected molded to ensure a snug fit with the cleaning member 200. The cleaning member 200 can have a first diameter, and the cavity 107 of the housing member 100 can have an interior diameter. The first diameter of the cleaning member 200 can be equal to or less than the diameter of the cavity 107 of the housing member 100 allowing for the cleaning member 200 to fit within the cavity 107 of the housing member 100. The cleaning member 200 can be removably coupled to the housing member 100 using any suitable means. In one exemplary embodiment, the diameter of the housing member 100 and cleaning member 200 can be close enough to allow for a friction fit between the two components but allow for the cleaning member 200 to be removable from the housing member 100. The cleaning member 200 friction fit can additionally prevent lateral movement of the cleaning member within the housing member 100 when being used by a user to remove particles 23 from a surface 21. The interchangeability of cleaning members 200 can allow for a second cleaning member to replace the first cleaning member when the first cleaning member has become worn and no longer effective. In other exemplary embodiments, the interior cavity 107 of the housing member can have one or more protrusions 109 to engage the cleaning member 200 to aid in maintaining the cleaning member within the cavity 107 of the housing member.

The cleaning member 200 can be comprised of any suitable material, including but not limited to an elastomeric material. In one exemplary embodiment, the cleaning member 200 can be comprised of a cross-linked polyethylene. Other exemplary embodiments can utilize other materials including other polymers that can effectively remove particles 23 from the paddle surface 21. In some exemplary embodiments the first cleaning member 200a can have a first set of material properties and a second cleaning member 200b can have a second set of material properties. In some exemplary embodiments, the cleaning apparatus 10 can have a housing member 100 with a plurality of cleaning members 200 that be interchangeable. The various cleaning members 200 can be configured to correspond to different surfaces 21. This can allow user to replace the cleaning members within the housing that may best clean the surface 21 of a paddle 20 as the texture and composition of paddle surfaces may vary. The different cleaning members 200 can have different properties, including but not limited to durometer. A first durometer can be greater than the second durometer between one or more of the cleaning members 200.

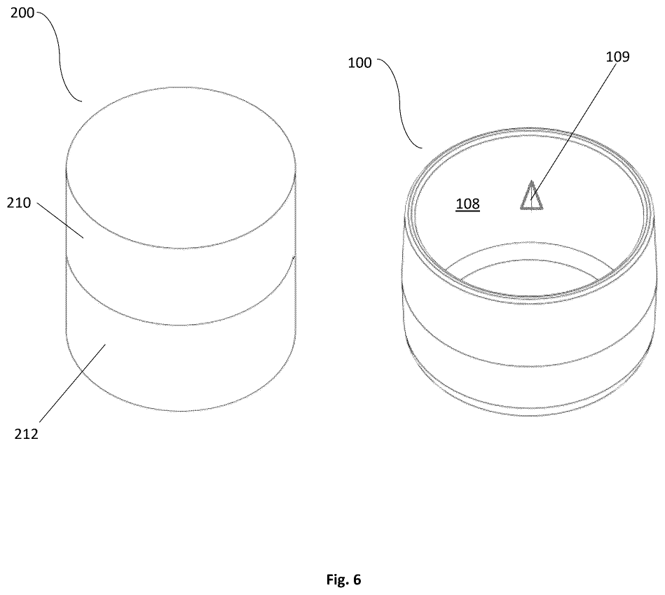

In other alternative embodiments shown in FIG. 6, a single cleaning member 200 can have a first portion 210 and a second portion 212. The first portion 210 and second portion 212 can be comprised of different or the same material. Additionally, the first portion 210 can be comprised of the material having a first set of material properties and a second portion 212 comprised of a material having second set of material properties. The first durometer and second durometer can be the same or alternative be different from one another to allow for a user to switch between durometer levels with a single cleaning member 200. Alternatively, different material characteristics between the first portion can be better adapted depending upon the surface 21 material or characteristics.

In some exemplary embodiments, the material properties can include but are not limited to material type, density, compressive strength, compression set, tensile strength, tear resistance, and Shore hardness or durometer. In some exemplary embodiments, the cleaning member 200 can be comprised of a cross-linked polyethylene material having a density between about 3.5 and 4.5, with a compressive strength between about 18-24 @ 25% and a compression set between about 8-12 @ 25%. The durometer of the cleaning member can be between about 45-65.

The housing member 100 and cleaning member 200 can be configured in various embodiments to ensure that adequate pressure can be applied to maintain the cleaning member within the housing. One or more protrusions can extend from the sidewall 108 of the cavity and interface with the sidewall 204 of the cleaning member 104. In some embodiments, more than half of the first cleaning member is positioned within the cavity of the housing member. In other embodiments at least three fourths of the cleaning member is positioned within the cavity of the housing member.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A surface cleaning apparatus, comprising:
a housing member having a first end and a second end, wherein the first end and second end can define the length of the housing member, wherein the first end is enclosed, and the second end is open, wherein a sidewall extending generally perpendicular from the first end towards the second end forms an interior cavity;
a first cleaning member having a first end and a second end, wherein the first end and second end can define the length of the cleaning member.

2. The apparatus of claim 2, wherein the first cleaning member is removably coupled to the housing member.

3. The apparatus of claim 3, wherein the first cleaning member has a length greater than the housing member.

4. The apparatus of claim 4, wherein a portion of the first cleaning member is positioned within the cavity of the housing member.

5. The apparatus of claim 5, wherein the first cleaning member is comprised of an elastomeric material.

6. The apparatus of claim 5, wherein the housing member is comprised of a polymer material.

7. The apparatus of claim 6, wherein the polymer material is cross-linked polyethylene.

8. The apparatus of claim 7, wherein the first cleaning member has a first durometer.

9. The apparatus of claim 8, further comprising a second cleaning member, wherein the second cleaning member has a second durometer.

10. The apparatus of claim 9, wherein the second durometer is greater than the first durometer.

11. The apparatus of claim 6, wherein the first end of the first cleaning member has a first portion comprised of a first material and a second portion comprised of a second material, wherein the first material has a first durometer and the second material of the first cleaning member has a second durometer.

12. The apparatus of claim 11, wherein the first durometer is less than the second durometer.

13. The apparatus of claim 7, wherein the first end of the first cleaning member is generally planar in configuration.

14. The apparatus of claim 8, wherein more than half of the length of the first cleaning member is positioned within the cavity of the housing member.

15. The apparatus of claim 8, wherein more than three fourths of the length of the cleaning member is positioned within the cavity of the housing member.

16. A surface cleaning apparatus for removing particles from the surface of a paddle comprising:
a housing member having a first end and a second end, wherein the first end and second end can define the length of the housing member, wherein the first end is enclosed, and the second end is open, wherein a sidewall extending generally perpendicular from the first end towards the second end forms an interior cavity;
a first cleaning member having a first end and a second end, wherein the first end and second end can define the length of the cleaning member, wherein at least a portion of the first cleaning member is configured to fit within the cavity of the housing member.

17. The apparatus of claim 16, wherein the cleaning member has an exterior diameter and the cavity of the housing member has an interior diameter, wherein the exterior diameter of the cleaning member is equal to or less than the interior diameter of the cavity of the housing member allowing for the cleaning member fit within the cavity of the housing member.

18. The apparatus of claim 17, wherein the cleaning member is comprised of a cross-linked polyethylene.
